(19) United States
(12) Patent Application Publication
(10) Pub. No.: US 2005/0097396 A1
(43) Pub. Date: May 5, 2005

(54) System and method for root cause linking of trouble tickets

(75) Inventor: Douglas A. Wood, Raleigh, NC (US)

Correspondence Address: Gerald R. Woods;IBM Corporation T81/503, PO Box 12195, Research Triangle Park, NC, 27709, US

(73) Assignee: International Business Machines Corporation, Armonk, NY (US)

(21) Appl. No.: 10/689,500

(22) Filed: Oct. 20, 2003

(51) Int. Cl. G06F 11/00

(52) U.S. Cl. 714/25

(57) ABSTRACT

A system and method for providing an accurate root cause failure by linking user incident reports to the root cause failure in a diagnostic database that reflects the system's current configuration. The system is pre-populated with pre-identified symptoms that are associated with assets in the system. The pre-identified symptoms are inactive until actual failures with assets are detected by a monitoring application. After the pre-identified symptoms become active, they are presented to service representatives who also answer calls from users. The activated pre-identified symptoms are used to assist the service representatives to solve problems observed by the users.

### BACKGROUND OF THE INVENTION

1. Field of the Invention

The present invention generally relates to computer systems, more specifically relates to computer diagnostic systems.

2. Description of the Related Art

In current practice, the integration between information technology (IT) management systems and service desk applications takes place at the incident tracking level, but not in the exchange of cause and effect knowledge or in observed state data. As a result of this, the service desk diagnostic system is static.

In current practice, service desk applications typical consist of some combination of the following components:

Call center automation—The call center automation component handles interactions between end users and service desk analysts. Traditionally it focuses on telephone call, but it may include any interaction mechanism such as email and instant message.

Incident reporting and tracking—The Incident reporting system tracks incident reports—often referred to as trouble tickets—from their creation to resolution. The basic life cycle of an incident is (1) registration, (2) evaluation, and (3) fulfillment.

Problem determination aids—Problem diagnostics aids consist of a diagnostics system that uses one or more diagnostic paradigms. Examples of diagnostic paradigms include keyword matching, full text search, decision trees, and artificial intelligence techniques such as RETE engines.

Integration with network and system monitoring applications—Automated systems that monitor the state of an IT environment are often integrated with the incident tracking system. Such systems create incident reports when they detect fault conditions in the environment.

Asset management systems—The asset management system provides reasonable current information about the state of the environment that can be utilized by other components.

Change management systems—The change management system manages the approval process for changes to the IT environment. It may also track the implementations of the changes. In the context of a service desk, this may be limited to changes required to implement solutions to a problem.

Service management systems—The service management system handles the dispatch and tracking of service personnel required to implement a problem solution.

The diagnostic system has knowledge about potential problems and their solutions. Such knowledge typically comes from three sources:

(1) Predefined knowledge provided by a third party. This knowledge is generally tied to a specific type of resource such as a specific vendor database. It does not take into account any of the specific characteristics of a given installation, thus it may be used without change by any installation that has the same resource type to which it pertains.

(2) Site-specific knowledge. This knowledge is similar in structure to the predefined knowledge, but it is created to reflect a specific operating environment. Because of this it can take into account know configurations and relationships in the environment.

(3) Historic knowledge. This is the result of previous successful problem diagnoses. It can be thought of as learning from experience.

The knowledge is used by analyzing symptoms described in a problem ticket and obtained by further interaction with the user submitting the ticket. Essentially the diagnostic process tries to create an accurate enough picture of the state of the environment that only a single solution applies.

In current practice, service desk diagnostic systems do little to reflect the known state of the IT environment. Typical problem diagnosis starts with a set of possible causes for the observed symptoms, then attempts to reduce the size of the set by making additional observations of the environment. This approach assumes that the actual state of the environment is unknown.

FIG. 1 illustrates the current practice. A user 102 observes faults or perceives faults in the IT environment and reports them to the service desk 104 as incident reports or trouble tickets 108. In the current practice, these reports are not correlated with monitoring performed by automated systems. The observations of end users are not considered valuable to automated monitoring systems for two reasons:

(1) Many, quite possible most trouble tickets opened by users do not pertain to the core systems with which automated monitoring systems are typically concerned.

(2) User observations are often imprecise and difficult for automated monitoring systems to utilize.

The incident report 108 is fed to a diagnostic engine 112 in a diagnostic system 110. The symptoms in the incident report 108 are compared against a list of symptoms 114 in the diagnostic system 110, and a solution 116 for the symptoms observed is then submitted to other systems, such as asset management system 118, change management system 120, and service management system 122.

### SUMMARY OF THE INVENTION

A system for providing an accurate root cause failure by linking user incident reports to the root cause failure in a diagnostic database that reflects the system's current configuration. The system includes a monitoring application for monitoring a plurality of assets and detecting failures with the plurality of assets, a diagnostic database for storing a plurality of pre-identified symptoms, and an incident tracking application for tracking user incident reports received from users. Each user incident report contains an observed symptom, and each pre-identified symptom is linked to at least one failure of an asset, wherein a pre-identified symptom is activated when the monitoring application detects a failure linked to the pre-identified symptom. After a user incident report is received, the observed symptom in the user incident report is matched up with an activated symptom in the diagnostic database, and the asset that is associated with the activated symptom is indicated as the root cause failure.

The system also includes an incident tracking database for storing the user incident reports. The monitoring application creates a system incident report for each failure detected with an asset and the system incident report is stored in the incident tracking database. The diagnostic database further stores a plurality of solutions, each solution being associated with at least one pre-identified symptom.

The invention also includes a method for for providing an accurate root cause failure by linking user incident reports to the root cause failure in a diagnostic database that reflects the system's current configuration. The method includes the steps of pre-populating a diagnostic database with a plurality of pre-identified symptoms, linking each pre-identified symptom with at least one failure of one asset, monitoring a plurality of assets, upon detecting a failure of an asset, activating at least one pre-identified symptom associated with the failed asset in the diagnostic database, receiving a user incident report from an user, and matching the observed symptom with an activated symptom in the diagnostic database. Each pre-identified symptom is linked to at least one solution, and each user incident report has at least one observed symptom. The asset associated with the matched symptom is the root cause failure.

The method may also includes the steps of retrieving a solution associated with the activated symptom and executing actions listed in the solution. Additionally, the method can include analyzing failure modes and devising the plurality of pre-identified symptoms. Finally, the method includes the steps of creating a system incident report for each failure detected and linking the system incident report to the activated symptom.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 depicts a system used in current practice.

FIG. 2 depicts a system according to the invention.

FIG. 3 depicts a root cause linking process.

FIG. 4 is a flow chart of a process to pre-populate a diagnostic system.

FIG. 5 is a flow chart for a failure detection process.

FIG. 6 is a flow chart for a root cause detection process.

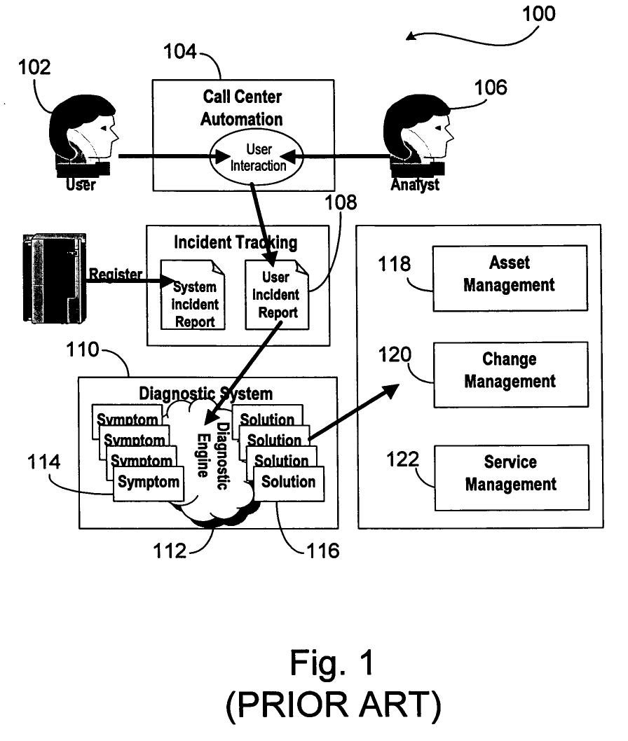

### DETAILED DESCRIPTION OF THE INVENTION

In this description, “failure” and “cause” are used interchangeably, like numerals refer to like elements throughout the several views. The service desk diagnostic system can be enhanced in three ways:

(1) by recognizing that human users of the IT environment are de facto monitoring agents for the state of the environment and making their observations available to automated systems monitoring the IT environment.

(2) by dynamically managing the set of symptoms in the service desk diagnostics system to reflect the observed state of the IT environment as reported by automated monitoring systems.

(3) by utilizing the dynamic changes to the diagnostic system to link many incident reports to a single root cause incident.

There are two countermanding factors that make it desirable to utilize user observations:

(1) users often have out of band communication mechanisms such as the telephone that allow them to report observation on parts of the environment that have been rendered invisible to automated tools by failures.

(2) humans are the most flexible monitoring agent in existence. Users may report conditions that no automated agent is configured to monitor.

The key to successful utilization of trouble ticket information by automated tools is to filter and condition the information. This can be accomplished by means of the service desk diagnostic system. The solution to certain problems involves generating an event for consumption by the automated system. This involves pre populating the service desk diagnostic system with “knowledge” that describes states of interest, which may be used by automated tools and are like candidates for end user observation. When a problem diagnosis process selects one of these states as the “solution” to a problem, an event is automatically generated. Information gathered during the diagnosis process may be added to the event. This allows a generic state description to be tailored to describe a specific failure. If the diagnostic system does not support automatic actions as part of problem resolution, then an analyst may manually generate an event.

Using knowledge about the state of the environment obtained from monitoring systems narrows the initial set of possible solutions and increases the chance of finding a successful solution for the problem detected. It is easier to determined the consequences of a known failure than finding the cause of an observed symptom.

The information on the consequence of possible failures can be utilized to populate the service desk diagnostic database. The information can be very specific taking into account the knowledge of the actual configuration and dependencies in the environment. The consequences of possible failures are the problem symptoms observed by the service desk.

Typically service desk diagnostic symptoms are general in nature. The approach described here allows symptoms to be more specific. The symptoms can be general and relate to consequences of a failure of a commonly deployed application, for example, the effects of a database deadlock on an e-commerce application. Alternatively, they can be very specific, for example, the effects on company A's store front application when the network switch X fails.

These potential symptoms are entered into the diagnostics database in a way that is consistent with the diagnostic techniques in use, for example keyword search or nodes in decision trees. Each potential symptom is related with one or more failure or cause. In many cases, the cause can be abstracted to the change in health of an IT asset. In these cases, a cause can be further linked to an asset. Each of the symptoms is marked as dormant and therefore unavailable for use by the diagnostic system. They are only potential symptoms because they are inactive until the state they are indicatory of is actually detected. And that state is the cause of the symptom.

In some cases, the cause and symptoms can be partially specified. These partially specified causes and symptoms are templates for a set of very similar failures. For example, failures that only vary by the name of the failing systems. When the actual failure occurs, the missing information is filled in.

Since the cause of the potential symptoms is known, the solutions are also known. Thus, all of the symptoms of a cause can be linked to a single solution that is the remedy for the cause.

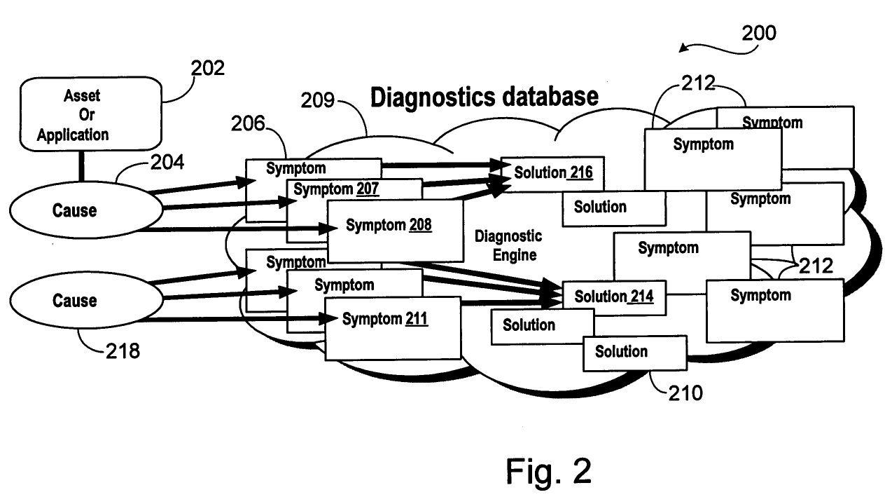

FIG. 2 illustrates a system 200 with a diagnostic database 209 with several symptoms. An asset 202 may be identified with one or more failures (causes) 204 and a cause may have multiple pre-identified symptoms 206, 207, 208. Two different pre-identified symptoms 208, 211 associated with two different causes 204 and 218 may point to the same solution 214. A pre-identified symptom 208 may also point to two different solutions 214, 216.

The diagnostic database 209 includes actual symptoms and potential symptoms. The actual symptoms are active pre-identified symptoms and associated with an actual failure or cause, and the potential symptoms are inactive pre-identified symptoms and associated with those failures that have not occurred yet. The actual symptoms and potential symptoms reflect the system's current configuration, and the actual symptoms reflects the system's current state (current IT state). In FIG. 2, when the asset 202 has a failure 204, the symptoms 206, 207, 208 become actual symptoms, while symptoms 212 are potential symptoms.

The potential symptoms may become actual (active) symptoms in two ways. A potential symptom become an activated symptom when a failure associated with a specific state is recognized. The automated monitoring application has rules that describe how a specific state associated with a failure is recognized. The rules have actions associated with them that are executed when the constraints of the rule are met. One of these actions can be to activate a symptom set in the service desk diagnostics database.

Another way for potential symptoms to become actual symptoms is for an automated monitoring application that monitors the health of IT assets to detect the change in health of an asset. When the change is detected, the status of the asset is updated in an asset registry. The registry provides for executing actions associated with this state change of the asset. One of these actions can be to activate a symptom set in the service desk diagnostics database. In either case the symptoms are again made inactive when the state they are related to no longer exists.

Once the link between an observed state and a symptom is established, it is possible to link additional incident reports to the observed state, which is the root cause of the incident reports. Most service desk applications aid in the resolution of incidents reported by end users through the use of diagnostic aids.

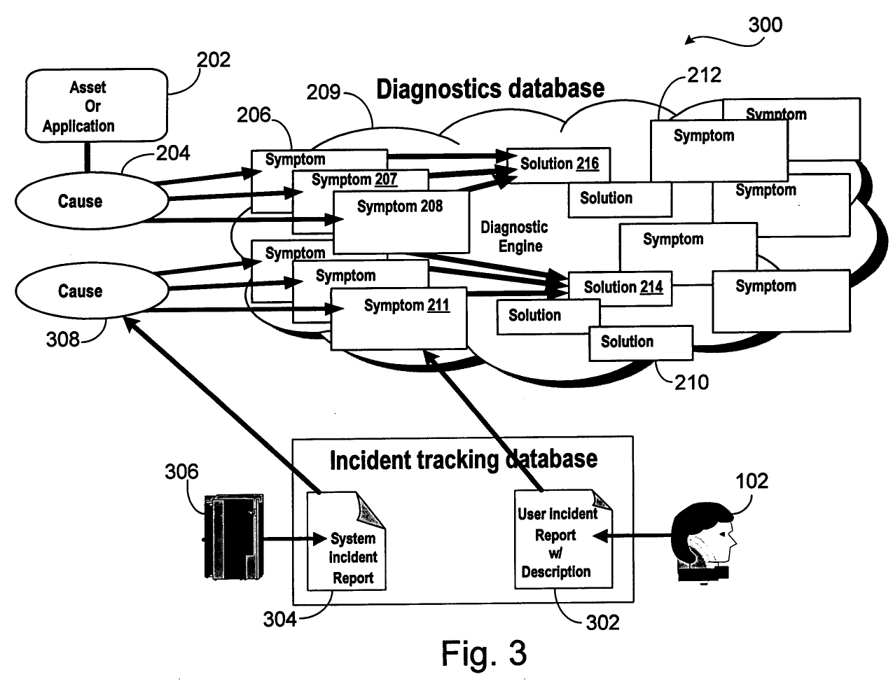

FIG. 3 illustrates a root cause linking process 300 according to the invention. A system failure may be observed with an equipment (asset) 306 and the failure is recorded in the system incident report 304. This failure may be a foreseeable failure (cause) 308 and the system incident report 304 is then linked to this cause 308. After linking the system incident report 304 with the cause 308, the symptoms associated with the cause 308 are activated. The system failure detection, reporting, and linking to a cause are done mostly automatically by an automated system monitoring process. The activated symptoms are available to service representatives at the service desk.

The system failure may cause problems to a user 102, who will report and describe the problems to a service representative at the service desk and recorded as a user incident report 302. The service representative records the description from the user 102 and attempts to match the description with an activated symptoms in the diagnostic database 209. A list of activated symptoms are presented to the service representative and the description matches to a symptom 211. The symptom 211 points to a solution 214, which will be presented to the service representative and possibly to the user 102. The user incident report 302 is also linked to the cause 308, and ultimately to the specific system failure reported in the system incident report 304.

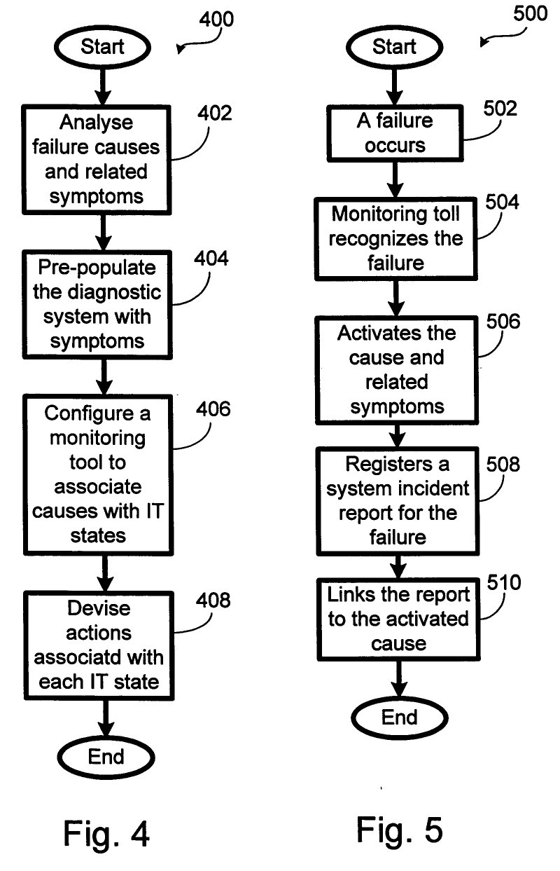

A service desk diagnostic system of the present invention takes advantage of a database with pre-identified symptoms and makes a set of activated symptoms available to service representatives. These activated symptoms reflect the current state of the system, and each state of the system is characterized by a set of symptoms. The system is pre-populated with causes, related symptoms, and solutions. FIG. 4 is a flow chart depicting a process 400 to pre-populate the diagnostic system. The IT environment is analyzed for know failure modes (causes) and their impact on the environment (symptoms), step 402. For each cause, a set of symptoms are entered in to the service desk diagnostics system, marked inactive, and linked to the cause, step 404. An automated monitoring system is configured to recognize the state of the IT environment that describes each cause, step 406. Actions are associated with the recognition of the state in the monitoring system, and these actions include activation of the related symptoms in the diagnostics system, creation of a system incident report in the incident tracking system, and relating the incident to a cause, step 408. Alternatively, the registration of a system incident and creation of a link to the cause could be handled by the service desk as part of the cause activation. The automated system may optionally be configured to recognize when a failure has been corrected. The recognition of correction of a failure may also be done manually. When the failure state no longer exists, the system incident report is closed and the symptoms are deactivated in the diagnostics system.

FIG. 5 is a flow chart for a failure detection process 500. When a failure occurs in the environment, step 502, the automated monitoring tool recognizes the failure, step 504. The monitoring tool activates the cause and related symptoms that have been pre populated in the service desk diagnostics system, step 506. If necessary, incident specific parameters such as the name of the failing system are filled in. The automated monitoring tool registers a system incident report for the failure, step 508. The automated monitoring tool links the system incident report to the activated cause, step 510.

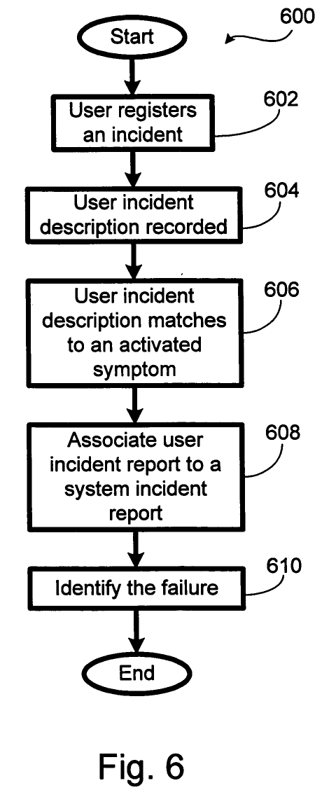

FIG. 6 is a flow chart for a root cause detection process 600. The root cause of a user incident is determined by use of the service desk diagnostics system. This may be accomplished either with the assistance of a call center analyst or directly by the user through some end user empowerment tool. When a user encounters a problem with an application or a system, the user registers a new user incident in the service desk incident tracking system, step 602. The description given by the user is recorded, step 604, and presented against a list of activated symptoms. The diagnostic system matches the user incident description to an activated symptom, step 606. The system incident, registered by the automated monitoring tool, that is linked to the activated symptom is associated with the user incident report, step 608, and the failure recorded in the system incident report is marked as that incidents root cause, step 610. The diagnostic engine may also retrieve a solution associated with the activated symptom and present the solution to the service representative for execution.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

1. A system for providing an accurate root cause failure by linking user incident reports to the root cause failure in a diagnostic database that reflects the system's current configuration, comprising:
a monitoring application for monitoring a plurality of assets and detecting failures with the plurality of assets;
a diagnostic database having a plurality of pre-identified symptoms, each pre-identified symptom being linked to at least one failure of an asset, wherein a pre-identified symptom is activated when the monitoring application detects a failure linked to the pre-identified symptom; and
an incident tracking application for tracking user incident reports received from users, each user incident report containing an observed symptom,
wherein, after a user incident report is received, the observed symptom in the user incident report is matched up with an activated pre-identified symptom in the diagnostic database, the asset that is associated with the activated symptom being the root cause failure.

2. The system of claim 1 further comprising an incident tracking database for storing the user incident reports.

3. The system of claim 1, wherein the monitoring application creates a system incident report for each failure detected with an asset.

4. The system of claim 3, wherein the system incident report is stored in the incident tracking database.

5. The system of claim 1, wherein the diagnostic database further stores a plurality of solutions, each solution being associated with at least one pre-identified symptom.

6. A method for for providing an accurate root cause failure by linking user incident reports to the root cause failure in a diagnostic database that reflects the system's current configuration, comprising the steps of:
pre-populating a diagnostic database with a plurality of pre-identified symptoms, each pre-identified symptom being linked to at least one solution;
linking each pre-identified symptom with at least one failure of one asset;
monitoring a plurality of assets;
upon detecting a failure of an asset, activating at least one pre-identified symptom associated with the failed asset in the diagnostic database;
receiving a user incident report from an user, wherein the user incident report having at least one observed symptom; and
matching the observed symptom with an activated pre-identified symptom in the diagnostic database, the asset associated with the matched symptom being the root cause failure.

7. The method of claim 6, further comprising the steps of:
retrieving a solution associated with the activated pre-identified symptom; and
executing actions listed in the solution.

8. The method of claim 6, further comprising the steps of:
analyzing failure modes; and
devising the plurality of pre-identified symptoms.

9. The method of claim 6, further comprising the steps of:
creating a system incident report for each failure detected; and
linking the system incident report to the activated pre-identified symptom.

10. A system for providing an accurate root cause failure by linking user incident reports to the root cause failure in a diagnostic database that reflects the system's current configuration, comprising:
first means for monitoring a plurality of assets and detecting failures with the plurality of assets;
second means for storing a plurality of pre-identified symptoms, each pre-identified symptom being linked to at least one failure of an asset, wherein a pre-identified symptom is activated when the first means detects a failure linked to the pre-identified symptom;
third means for tracking user incident reports received from users, each user incident report containing an observed symptom,
wherein, after a user incident report is received, the observed symptom in the user incident report is matched up with an activated pre-identified symptom in the second means, the asset that is associated with the activated symptom being the root cause failure.
